(19) United States
(12) Patent Application Publication
(10) Pub. No.: US 2014/0294182 A1
(43) Pub. Date: Oct. 2, 2014

(54) SYSTEMS AND METHODS FOR LOCATING AN ERROR MICROPHONE TO MINIMIZE OR REDUCE OBSTRUCTION OF AN ACOUSTIC TRANSDUCER WAVE PATH

(71) Applicant: Cirrus Logic, Inc., Austin, TX (US)

(72) Inventors: Jens-Peter B. Axelsson, Austin, TX (US); John L. Melanson, Austin, TX (US)

(21) Appl. No.: 13/931,133

(22) Filed: Jun. 28, 2013

Related U.S. Application Data
(60) Provisional application No. 61/806,200, filed on Mar. 28, 2013.

(51) Int. Cl. H04R 29/00

(52) U.S. Cl. CPC H04R 29/001
USPC 381/56

(57) ABSTRACT

An apparatus may include an acoustic transducer, a housing, a microphone, and an acoustical conduit. The acoustic transducer may include a diaphragm having a front and a back, the diaphragm configured to mechanically vibrate in response to an audio signal, thereby producing sound from the front of the diaphragm. The housing may be configured to mechanically support the acoustic transducer such that the front faces an exterior of the housing and the back faces an interior of the housing. The microphone may be disposed in the interior of the housing and may be configured to sense combined sound produced by the acoustic transducer and ambient sound proximate to the acoustic transducer. The acoustical conduit may be coupled to and extend from the microphone and pass adjacent the acoustic transducer such that the microphone senses sound proximate to the front of the diaphragm.

### RELATED APPLICATION

The present disclosure claims priority to U.S. Provisional Patent Application Ser. No. 61/806,200, filed Mar. 28, 2013, which is incorporated by reference herein in its entirety.

### FIELD OF DISCLOSURE

The present disclosure relates in general to adaptive noise cancellation in connection with an acoustic transducer, and more particularly, to locating an error microphone associated with the acoustic transducer to minimize or reduce obstructions of an acoustic transducer wave path.

### BACKGROUND

Wireless telephones, such as mobile/cellular telephones, cordless telephones, and other consumer audio devices, such as mp3 players, are in widespread use. Performance of such devices with respect to intelligibility can be improved by providing noise canceling using a microphone to measure ambient acoustic events and then using signal processing to insert an anti-noise signal into the output of the device to cancel the ambient acoustic events. Noise canceling approaches often employ an error microphone for sensing a combined acoustic pressure (e.g., combination of desired sound and undesired ambient noise) near a listener's ear drum in order to remove undesired components (e.g., the undesired ambient noise) of the combined acoustic pressure.

However, for portable or small audio devices with loudspeakers or acoustic transducers, such as wireless telephones and headphones, locating an error microphone at an appropriate place within the device can be challenging. For example, due to space limitations of such devices, confined spaces inherent in such devices may render challenges in locating an error microphone. As another example, space is so limited that attempting to mount an error microphone near or at the exit of the acoustical path of the loudspeaker or acoustic transducer may be difficult and/or may obstruct the wave path of the loudspeaker or acoustic transducer.

### SUMMARY

In accordance with the teachings of the present disclosure, the disadvantages and problems associated with locating an error microphone associated with an acoustic transducer may be reduced or eliminated.

In accordance with embodiments of the present disclosure, an apparatus may include an acoustic transducer, a housing, a microphone, and an acoustical conduit. The acoustic transducer may include a diaphragm having a front and a back, the diaphragm configured to mechanically vibrate in response to an audio signal input to the acoustic transducer, thereby producing sound from the front of the diaphragm. The housing may be configured to mechanically support the acoustic transducer such that the front faces an exterior of the housing and the back faces an interior of the housing. The microphone may be disposed in the interior of the housing and may be configured to sense combined sound produced by the acoustic transducer and ambient sound proximate to the acoustic transducer. The acoustical conduit may be coupled to and extend from the microphone and pass adjacent the acoustic transducer such that the microphone senses sound proximate to the front of the diaphragm.

In accordance with these and other embodiments of the present disclosure, an apparatus may include an acoustic transducer, a first acoustical conduit, a microphone, and a second acoustical conduit. The acoustic transducer may be configured to produce sound in response to an audio signal input to the acoustic transducer. The first acoustical conduit may be coupled to and extend from the acoustic transducer and may be configured to acoustically conduct sound from the acoustic transducer to an end of the acoustical conduit opposite the acoustic transducer. The microphone may be configured to sense combined sound produced by the acoustic transducer and ambient sound proximate to the end of the first acoustical conduit opposite the acoustic transducer. The second acoustical conduit may be coupled to and extend from the microphone and to a location proximate to the end of the first acoustical conduit opposite the acoustic transducer such that the microphone senses sound proximate to the end of the first acoustical conduit.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is an illustration of an example wireless mobile telephone, in accordance with embodiments of the present disclosure;

FIG. 1B is an illustration of an example wireless mobile telephone with a headphone assembly coupled thereto, in accordance with embodiments of the present disclosure;

FIG. 2 is a block diagram of selected circuits within the wireless telephone depicted in FIG. 1, in accordance with embodiments of the present disclosure;

FIG. 3 is a block diagram depicting selected signal processing circuits and functional blocks within an example active noise canceling (ANC) circuit of a coder-decoder (CODEC) integrated circuit of FIG. 3, in accordance with embodiments of the present disclosure;

FIGS. 4A and 4B are each an illustration including a cross-sectional elevation view of an example acoustic transducer configuration, in accordance with embodiments of the present disclosure;

FIG. 5A is an illustration including a cross-sectional elevation view of an example intra-canal earphone having a dynamic acoustic transducer, in accordance with embodiments of the present disclosure;

FIG. 5B is an illustration including a cross-sectional plan view of the intra-canal earphone depicted in FIG. 5A, in accordance with embodiments of the present disclosure;

FIG. 6A is an illustration including a cross-sectional elevation view of another example intra-canal earphone having a dynamic acoustic transducer, in accordance with embodiments of the present disclosure;

FIG. 6B is an illustration including a cross-sectional plan view of the example intra-canal earphone depicted in FIG. 6A having a dynamic acoustic transducer, in accordance with embodiments of the present disclosure;

FIG. 7 is an illustration including a cross-sectional elevation view of an example intra-canal earphone having a balanced armature acoustic transducer, in accordance with embodiments of the present disclosure;

FIG. 8 is an illustration including a cross-sectional elevation view of an example intra-concha earphone having a dynamic acoustic transducer, in accordance with embodiments of the present disclosure; and

FIGS. 9A and 9B are each an illustration including a cross-sectional elevation view of a microphone port tube terminus, in accordance with embodiments of the present disclosure.

### DETAILED DESCRIPTION

The present disclosure encompasses noise canceling techniques and circuits that can be implemented in a personal audio device, such as a wireless telephone. The personal audio device includes an ANC circuit that may measure the ambient acoustic environment and generate a signal that is injected in the speaker (or other transducer) output to cancel ambient acoustic events. A reference microphone may be provided to measure the ambient acoustic environment and an error microphone may be included for controlling the adaptation of the anti-noise signal to cancel the ambient audio sounds and for correcting for the electro-acoustic path from the output of the processing circuit through the transducer.

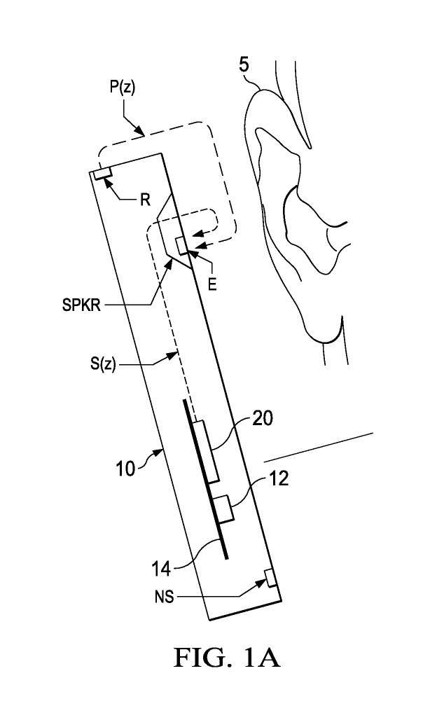

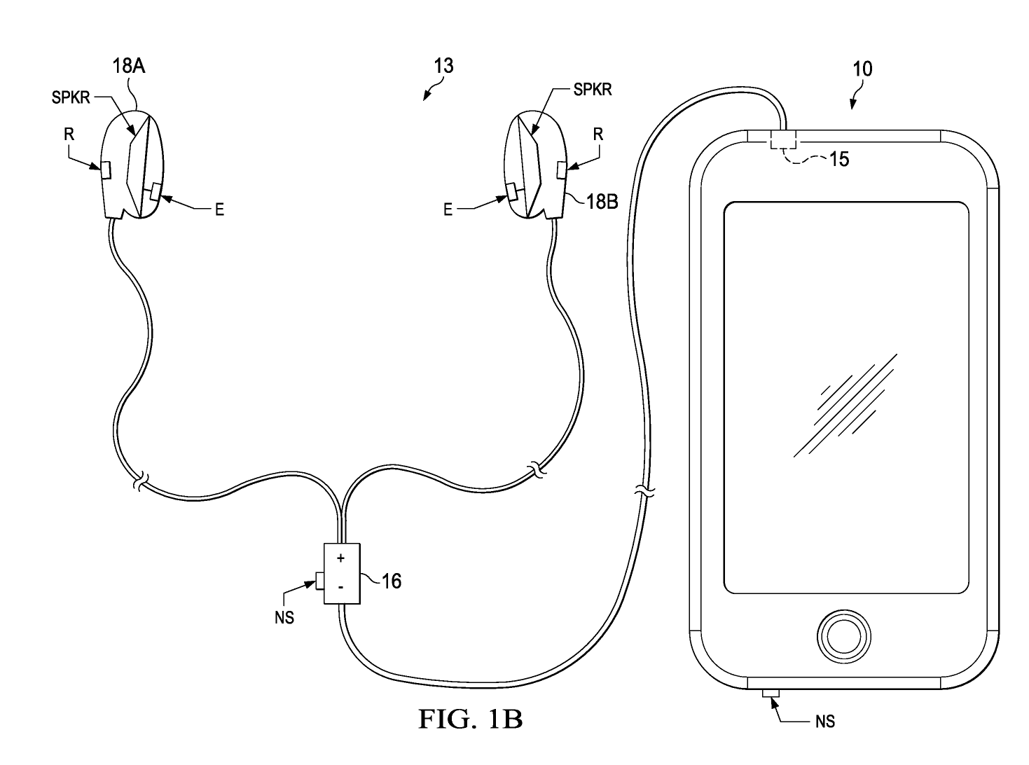

Referring now to FIG. 1A, a wireless telephone 10 as illustrated in accordance with embodiments of the present disclosure is shown in proximity to a human ear 5. Wireless telephone 10 is an example of a device in which techniques in accordance with embodiments of the invention may be employed, but it is understood that not all of the elements or configurations embodied in illustrated wireless telephone 10, or in the circuits depicted in subsequent illustrations, are required in order to practice the invention recited in the claims. Wireless telephone 10 may include a transducer such as speaker SPKR that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from webpages or other network communications received by wireless telephone 10 and audio indications such as a low battery indication and other system event notifications. A near-speech microphone NS may be provided to capture near-end speech, which is transmitted from wireless telephone 10 to the other conversation participant(s).

Wireless telephone 10 may include ANC circuits and features that inject an anti-noise signal into speaker SPKR to improve intelligibility of the distant speech and other audio reproduced by speaker SPKR. A reference microphone R may be provided for measuring the ambient acoustic environment, and may be positioned away from the typical position of a user's mouth, so that the near-end speech may be minimized in the signal produced by reference microphone R. Another microphone, error microphone E, may be provided in order to further improve the ANC operation by providing a measure of the ambient audio combined with the audio reproduced by speaker SPKR close to ear 5, when wireless telephone 10 is in close proximity to ear 5. Circuit 14 within wireless telephone 10 may include an audio CODEC integrated circuit (IC) 20 that receives the signals from reference microphone R, near-speech microphone NS, and error microphone E, and interfaces with other integrated circuits such as a radio-frequency (RF) integrated circuit 12 having a wireless telephone transceiver. In some embodiments of the disclosure, the circuits and techniques disclosed herein may be incorporated in a single integrated circuit that includes control circuits and other functionality for implementing the entirety of the personal audio device, such as an MP3 player-on-a-chip integrated circuit. In these and other embodiments, the circuits and techniques disclosed herein may be implemented partially or fully in software and/or firmware embodied in computer-readable media and executable by a controller or other processing device.

In general, ANC techniques of the present disclosure measure ambient acoustic events (as opposed to the output of speaker SPKR and/or the near-end speech) impinging on reference microphone R, and by also measuring the same ambient acoustic events impinging on error microphone E, ANC processing circuits of wireless telephone 10 adapt an anti-noise signal generated out the output of speaker SPKR from the output of reference microphone R to have a characteristic that minimizes the amplitude of the ambient acoustic events at error microphone E. Because acoustic path P(z) extends from reference microphone R to error microphone E, ANC circuits are effectively estimating acoustic path P(z) while removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which may be affected by the proximity and structure of ear 5 and other physical objects and human head structures that may be in proximity to wireless telephone 10, when wireless telephone 10 is not firmly pressed to ear 5. While the illustrated wireless telephone 10 includes a two-microphone ANC system with a third near-speech microphone NS, some aspects of the present invention may be practiced in a system that does not include separate error and reference microphones, or a wireless telephone that uses near-speech microphone NS to perform the function of the reference microphone R. Also, in personal audio devices designed only for audio playback, near-speech microphone NS will generally not be included, and the near-speech signal paths in the circuits described in further detail below may be omitted, without changing the scope of the disclosure, other than to limit the options provided for input to the microphone covering detection schemes. In addition, although only one reference microphone R is depicted in FIG. 1, the circuits and techniques herein disclosed may be adapted, without changing the scope of the disclosure, to personal audio devices including a plurality of reference microphones.

Referring now to FIG. 1B, wireless telephone 10 is depicted having a headphone assembly 13 coupled to it via audio port 15. Audio port 15 may be communicatively coupled to RF integrated circuit 12 and/or CODEC IC 20, thus permitting communication between components of headphone assembly 13 and one or more of RF integrated circuit 12 and/or CODEC IC 20. As shown in FIG. 1B, headphone assembly 13 may include a combox 16, a left headphone 18A, and a right headphone 18B. As used in this disclosure, the term “headphone” broadly includes any loudspeaker and structure associated therewith that is intended to be mechanically held in place proximate to a listener's ear or ear canal, and includes without limitation earphones, earbuds, and other similar devices. As more specific non-limiting examples, “headphone,” may refer to intra-canal earphones, intra-concha earphones, supra-concha earphones, and supra-aural earphones.

Combox 16 or another portion of headphone assembly 13 may have a near-speech microphone NS to capture near-end speech in addition to or in lieu of near-speech microphone NS of wireless telephone 10. In addition, each headphone 18A, 18B may include a transducer such as speaker SPKR that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from webpages or other network communications received by wireless telephone 10 and audio indications such as a low battery indication and other system event notifications. Each headphone 18A, 18B may include a reference microphone R for measuring the ambient acoustic environment and an error microphone E for measuring of the ambient audio combined with the audio reproduced by speaker SPKR close a listener's ear when such headphone 18A, 18B is engaged with the listener's ear. In some embodiments, CODEC IC 20 may receive the signals from reference microphone R, near-speech microphone NS, and error microphone E of each headphone and perform adaptive noise cancellation for each headphone as described herein. In other embodiments, a CODEC IC or another circuit may be present within headphone assembly 13, communicatively coupled to reference microphone R, near-speech microphone NS, and error microphone E, and configured to perform adaptive noise cancellation as described herein.

The various microphones referenced in this disclosure, including reference microphones, error microphones, and near-speech microphones, may comprise any system, device, or apparatus configured to convert sound incident at such microphone to an electrical signal that may be processed by a controller, and may include without limitation an electrostatic microphone, a condenser microphone, an electret microphone, an analog microelectromechanical systems (MEMS) microphone, a digital MEMS microphone, a piezoelectric microphone, a piezo-ceramic microphone, or dynamic microphone.

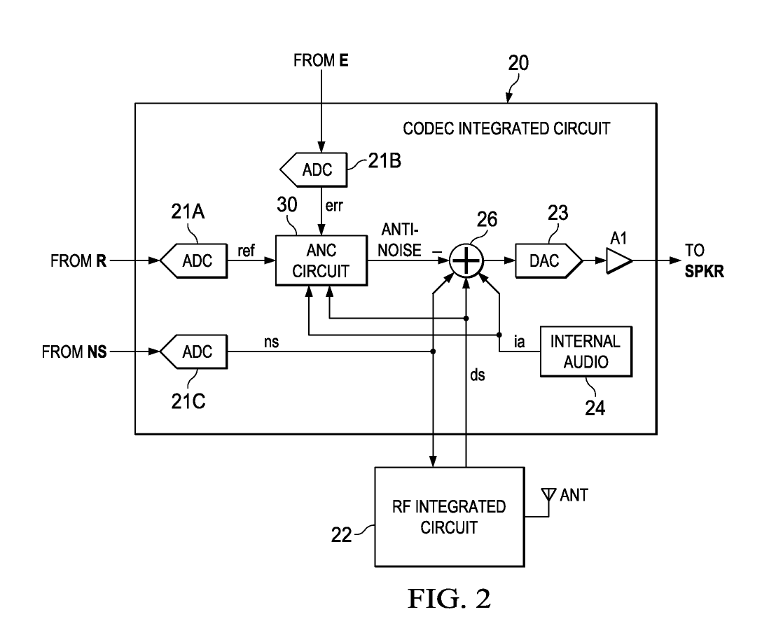

Referring now to FIG. 2, selected circuits within wireless telephone 10, which in other embodiments may be placed in whole or part in other locations such as one or more headphone assemblies 13, are shown in a block diagram. CODEC IC 20 may include an analog-to-digital converter (ADC) 21A for receiving the reference microphone signal and generating a digital representation ref of the reference microphone signal, an ADC 21B for receiving the error microphone signal and generating a digital representation err of the error microphone signal, and an ADC 21C for receiving the near speech microphone signal and generating a digital representation ns of the near speech microphone signal. CODEC IC 20 may generate an output for driving speaker SPKR from an amplifier A1, which may amplify the output of a digital-to-analog converter (DAC) 23 that receives the output of a combiner 26. Combiner 26 may combine audio signals is from internal audio sources 24, the anti-noise signal generated by ANC circuit 30, which by convention has the same polarity as the noise in reference microphone signal ref and is therefore subtracted by combiner 26, and a portion of near speech microphone signal ns so that the user of wireless telephone 10 may hear his or her own voice in proper relation to downlink speech ds, which may be received from radio frequency (RF) integrated circuit 22 and may also be combined by combiner 26. Near speech microphone signal ns may also be provided to RF integrated circuit 22 and may be transmitted as uplink speech to the service provider via antenna ANT.

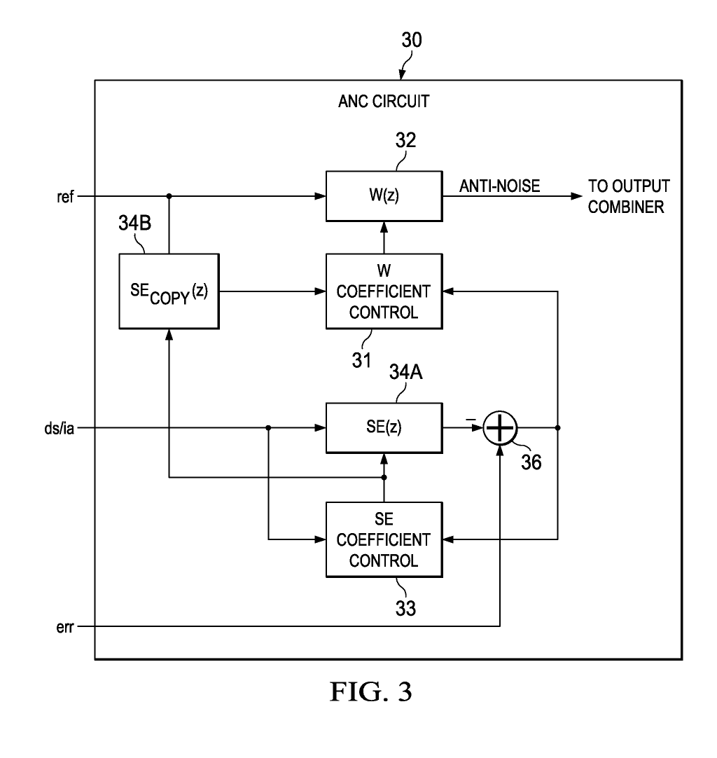

Referring now to FIG. 3, details of ANC circuit 30 are shown in accordance with embodiments of the present disclosure. Adaptive filter 32 may receive reference microphone signal ref and under ideal circumstances, may adapt its transfer function W(z) to be P(z)/S(z) to generate the anti-noise signal, which may be provided to an output combiner that combines the anti-noise signal with the audio to be reproduced by the transducer, as exemplified by combiner 26 of FIG. 2. The coefficients of adaptive filter 32 may be controlled by a W coefficient control block 31 that uses a correlation of signals to determine the response of adaptive filter 32, which generally minimizes the error, in a least-mean squares sense, between those components of reference microphone signal ref present in error microphone signal err. The signals compared by W coefficient control block 31 may be the reference microphone signal ref as shaped by a copy of an estimate of the response of path S(z) provided by filter 34B and another signal that includes error microphone signal err. By transforming reference microphone signal ref with a copy of the estimate of the response of path S(z), response SE_{COPY}(z), and minimizing the difference between the resultant signal and error microphone signal err, adaptive filter 32 may adapt to the desired response of P(z)/S(z). In addition to error microphone signal err, the signal compared to the output of filter 34B by W coefficient control block 31 may include an inverted amount of downlink audio signal ds and/or internal audio signal ia that has been processed by filter response SE(z), of which response SE_{COPY}(z) is a copy. By injecting an inverted amount of downlink audio signal ds and/or internal audio signal ia, adaptive filter 32 may be prevented from adapting to the relatively large amount of downlink audio and/or internal audio signal present in error microphone signal err and by transforming that inverted copy of downlink audio signal ds and/or internal audio signal ia with the estimate of the response of path S(z), the downlink audio and/or internal audio that is removed from error microphone signal err before comparison should match the expected version of downlink audio signal ds and/or internal audio signal ia reproduced at error microphone signal err, because the electrical and acoustical path of S(z) is the path taken by downlink audio signal ds and/or internal audio signal ia to arrive at error microphone E. Filter 34B may not be an adaptive filter, per se, but may have an adjustable response that is tuned to match the response of adaptive filter 34A, so that the response of filter 34B tracks the adapting of adaptive filter 34A.

To implement the above, adaptive filter 34A may have coefficients controlled by SE coefficient control block 33, which may compare downlink audio signal ds and/or internal audio signal ia and error microphone signal err after removal of the above-described filtered downlink audio signal ds and/or internal audio signal ia, that has been filtered by adaptive filter 34A to represent the expected downlink audio delivered to error microphone E, and which is removed from the output of adaptive filter 34A by a combiner 36. SE coefficient control block 33 correlates the actual downlink speech signal ds and/or internal audio signal ia with the components of downlink audio signal ds and/or internal audio signal ia that are present in error microphone signal err. Adaptive filter 34A may thereby be adapted to generate a signal from downlink audio signal ds and/or internal audio signal ia, that when subtracted from error microphone signal err, contains the content of error microphone signal err that is not due to downlink audio signal ds and/or internal audio signal ia.

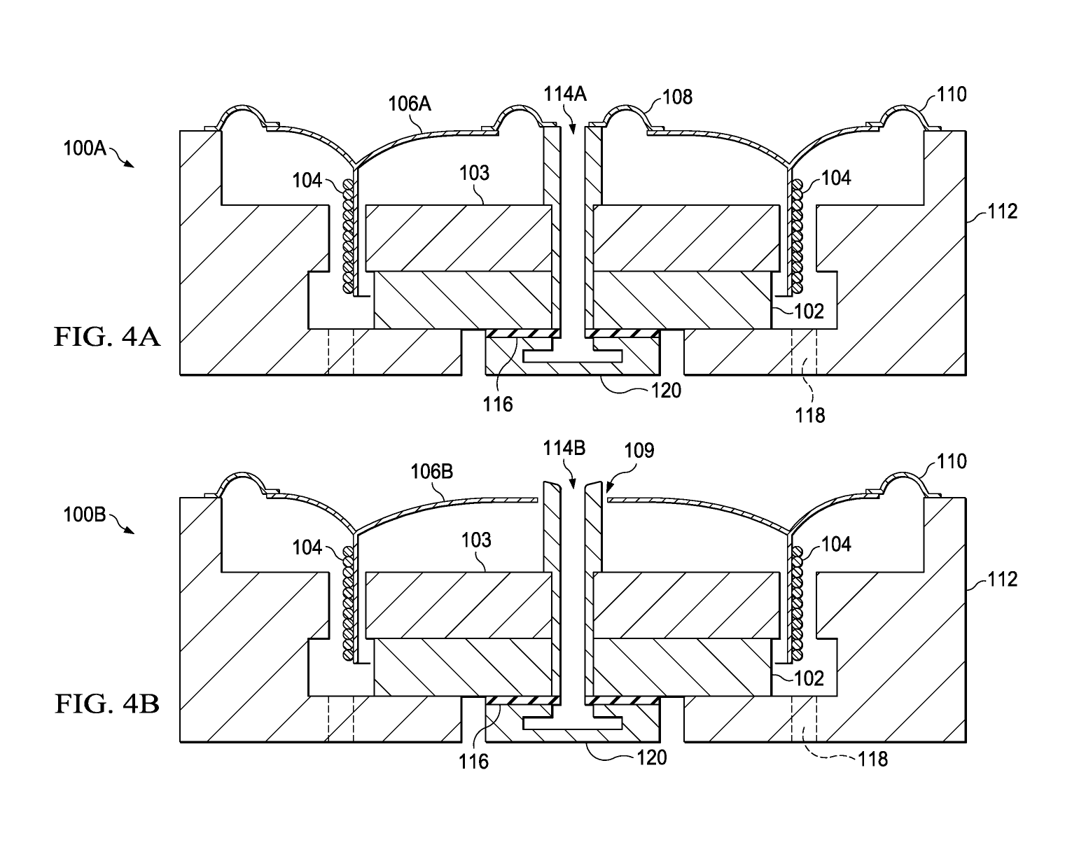

FIG. 4A is an illustration including a cross-sectional elevation view of an example acoustic transducer configuration 100A, in accordance with embodiments of the present disclosure. Acoustic transducer configuration 100A may be used in a smart phones, cell phones (e.g., wireless telephone 10), hand-held communication devices, or any other devices encompassing loudspeakers. Acoustic transducer configuration 100A may be particularly useful for devices that incorporate adaptive noise cancellation and/or feedback-based signal processing solutions for improving the sound quality of the loudspeaker. Acoustic transducer configuration 100A may include a magnet 102, a yoke/top plate 103, a voice coil 104, a diaphragm/cone 106A, a center surround area 108, a perimeter surround area 110, and a basket/back plate 112 coupled together and configured as shown in FIG. 4A, and may operate as a loudspeaker. Diaphragm/cone 106A may have a front and a back, and may be configured to mechanically vibrate in response to an audio signal input to voice coil 104, thereby producing sound from the front of diaphragm/cone 106A. A vent hole 118 may exist in and for the acoustic transducer configuration 100A as shown in FIG. 4A. Together, the foregoing components of acoustic transducer configuration 100A may be disposed in a housing configured to mechanically support the acoustic transducer formed by the various components such that the front of the acoustic transducer (from which sounds generated by the acoustic transducer originate) faces an exterior of the housing (the upward direction of FIG. 4A) and the back faces an interior of the housing (the downward direction of FIG. 4A).

An error microphone 120 may be mounted near, proximate, or to the interior of the housing of acoustic transducer configuration 100A (e.g., the back of the acoustic transducer configuration 100A) and may be configured to sense combined acoustical pressure of sound produced by diaphragm/cone 106A and ambient sound proximate to diaphragm/cone 106A. A gasket 116 may be located between error microphone 120 and the back of acoustic transducer configuration 100A. A microphone port tube 114A may be coupled to error microphone 120. Microphone port tube 114A may comprise any acoustical conduit coupled to and extending from the microphone and passing adjacent to the acoustic transducer such that acoustical pressure present proximate to the front of diaphragm/cone 106A is communicated to error microphone 120. In some embodiments, microphone port tube 114A may pass through the acoustic transducer such that acoustical pressure present proximate to the front of diaphragm/cone 106A is communicated to error microphone 120. Microphone port tube 114A may have any suitable shape and/or cross section, including an open cylindrical tube (e.g., circular cylindrical tube, triangular cylindrical tube, rectangular cylindrical tube, etc.). In some embodiments, microphone port tube 114A may be placed and mounted trans-axially through the center of acoustic transducer configuration 100A, such that error microphone 120 is generally located behind the speaker/acoustic transducer. The microphone port provided by microphone port tube 114A may pass through the center of acoustic transducer configuration 100A and such that error microphone 120 senses acoustic pressure proximate to the front of diaphragm/cone 106A. For the types of applications that acoustic transducer configuration 100A may generally be used, the end of microphone port tube 114A near the front of acoustic transducer configuration 100A may be generally or near flush with the diaphragm/cone 106A.

The size or area of the microphone port tube 114A may be much smaller than the size or area of the error microphone 120. For example, in some embodiments, the size or area of the microphone port tube 114A may be in the order of five (5) to ten (10) times less than the size or area of the error microphone 120. As a specific example, a typical size of the cross-sectional area of microphone port tube 114A may be approximately one (1) square millimeter while the area of error microphone 120 may be approximately ten (10) square millimeters. Thus, the microphone port tube 114A may not significantly obstruct the functionality or acoustic wave path of acoustic transducer configuration 100A. This type of arrangement can be particularly useful for types of loudspeakers in which feedback of the acoustic output in front of the loudspeaker is desired.

FIG. 4B is an illustration including a cross-sectional elevation view of an example acoustic transducer configuration 100B, in accordance with embodiments of the present disclosure. In some embodiments, acoustic transducer configuration 100B may be used in a headphone (e.g., headphones 18A, 18B) and other such devices that encompass acoustic transducers. Acoustic transducer configuration 100B is similar to acoustic transducer configuration 100A, so discussion of acoustic transducer configuration 100B herein will focus mainly on the differences between acoustic transducer configuration 100B from acoustic transducer configuration 100A.

Acoustic transducer configuration 100B may include a microphone port tube 114B that also extends through the center of the acoustic transducer configuration 100B. Microphone port tube 114B may comprise any acoustical conduit coupled to and extending from the microphone and passing adjacent to the acoustic transducer such that acoustical pressure present proximate to the front of diaphragm/cone 106B is communicated to error microphone 120. In some embodiments, microphone port tube 114B may pass through the acoustic transducer such that acoustical pressure present proximate to the front of diaphragm/cone 106B is communicated to error microphone 120. Microphone port tube 114B may have any suitable shape and/or cross section, including an open cylindrical tube (e.g., circular cylindrical tube, triangular cylindrical tube, rectangular cylindrical tube, etc.). In the embodiments represented by FIG. 4B, diaphragm/cone 106B may not comprise a center surround area 108 but instead may include an air gap 109 between microphone port tube 114B and diaphragm/cone 106B. A portion of microphone port tube 114B may extend beyond (further in front) of diaphragm/cone 106B so that the air gap 109 maintains a substantially constant air gap value between the microphone port tube 114B and diaphragm/cone 106B. Similar to diaphragm/cone 106A, diaphragm/cone 106B may have a front and a back, and may be configured to mechanically vibrate in response to an audio signal input to voice coil 104, thereby producing sound from the front of diaphragm/cone 106A. Also, similar to microphone port tube 114A, the size or area of the microphone port tube 114B may also be much smaller than the size or area of the error microphone 120. Error microphone 120 may also be generally located behind the acoustic transducer, such that the microphone port tube 114B and error microphone 120 may not substantially obstruct the functionality or acoustic wave path of acoustic transducer configuration 100B.

In addition, although not explicitly shown in FIGS. 4A and 4B, personal audio devices including the embodiments of acoustic transducer configurations represented by FIGS. 4A and 4B may also include a reference microphone. Such reference microphone may be placed on and/or within the housings of acoustic transducer configurations 100A or 100B or elsewhere in a personal audio device having either of acoustic transducer configurations 100A or 100B.

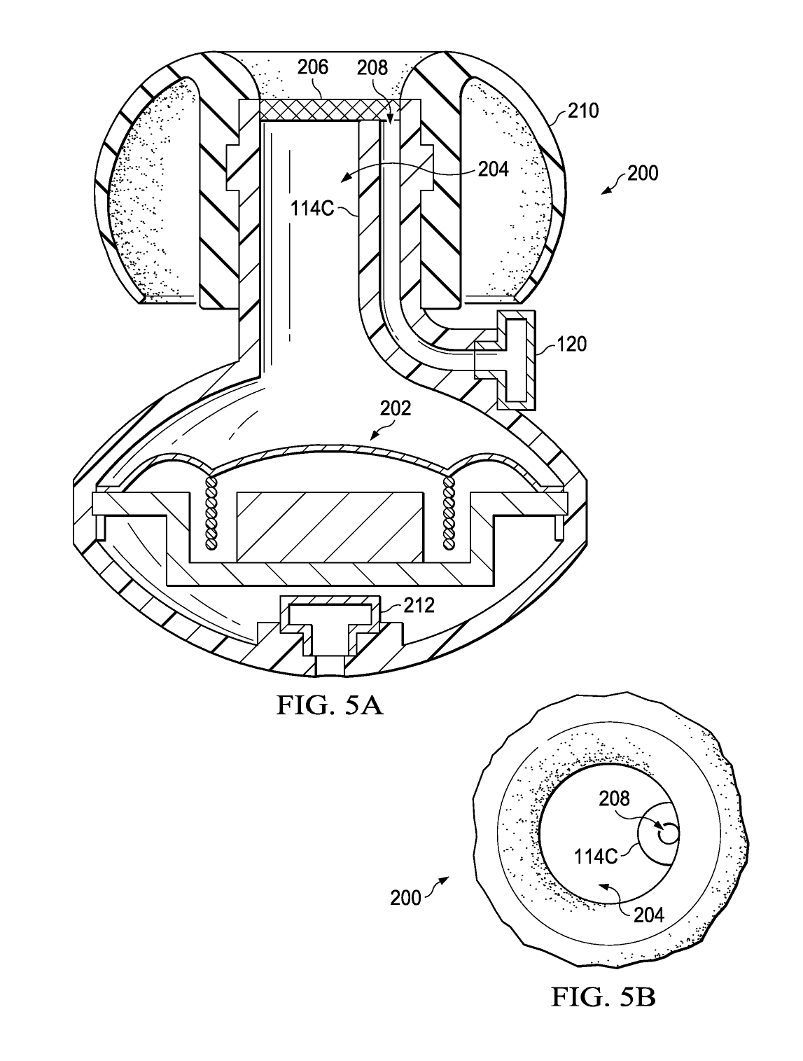

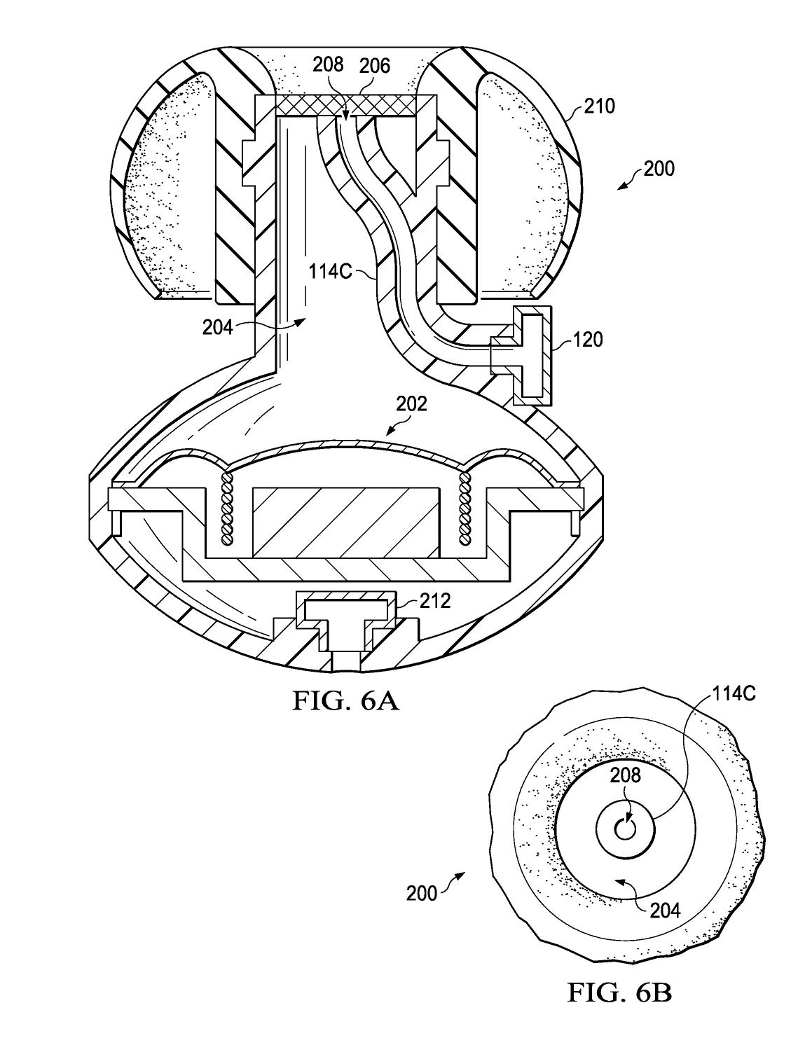

FIGS. 5A and 5B illustrate a cross-sectional elevation view and a cross-sectional plan view, respectively, of an example intra-canal earphone 200 having a dynamic acoustic transducer 202, in accordance with embodiments of the present disclosure. Earphone 200 may be particularly useful for headphone assemblies that either incorporate or are used with devices that incorporate adaptive noise cancellation and/or feedback-based signal processing solutions for improving the sound quality of the insert earphone. Earphone 200 may comprise a housing including a dynamic acoustic transducer 202, a speaker tube 204, a screen 206, and inserts 210 coupled together and configured in a manner similar to that depicted in FIGS. 5A and 5B. A reference microphone 212 may also be mounted towards the back of earphone 200 as generally shown in FIG. 5A. An error microphone 120 may be mounted and located to a side of earphone 200. A microphone port tube 114C may be coupled to error microphone 120 as shown in FIG. 5A. Microphone port tube 114C may extend from error microphone 120 at a side of earphone 200 to a side of screen 206 and an error microphone tube entrance 208 may abut a side of screen 206. Alternatively, as shown in FIGS. 6A and 6B, error microphone tube entrance 208 may instead abut the center of screen 206.

Microphone port tube 114C may comprise any acoustical conduit coupled to and extending from the microphone and passing through or otherwise adjacent to screen 206 such that an acoustical pressure present proximate to the front of screen 206 is communicated to error microphone 120. Microphone port tube 114C may have any suitable shape and/or cross section, including an open cylindrical tube (e.g., circular cylindrical tube, triangular cylindrical tube, rectangular cylindrical tube, etc.). Similar to microphone port tube 114A, the size or area of the microphone port tube 114C may be much smaller than the size or area of the error microphone 120. Due to the size and/or placement of microphone port tube 114C and error microphone 120, microphone port tube 114C and error microphone 120 may not substantially obstruct the functionality or acoustic wave path of dynamic acoustic transducer 202.

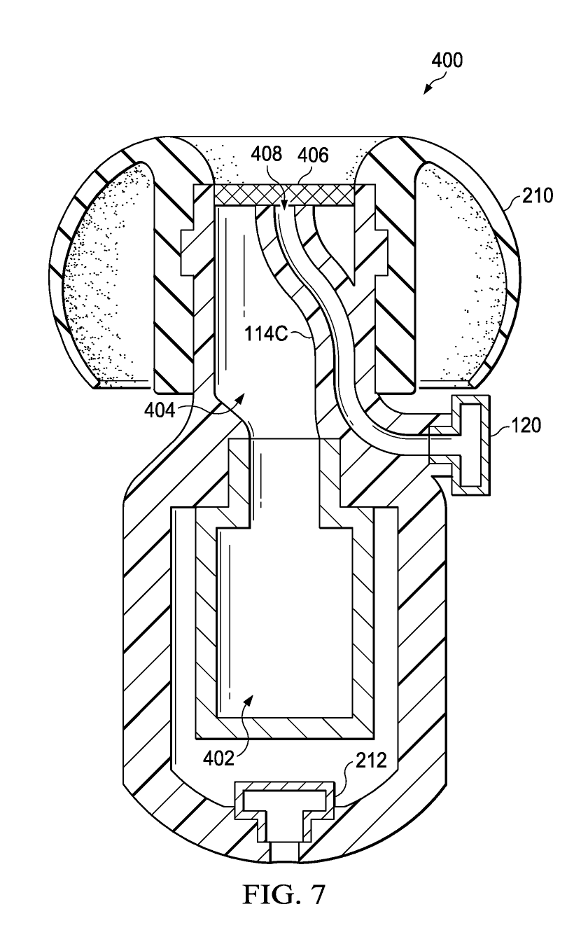

FIG. 7 is an illustration including a cross-sectional elevation view of an example intra-canal earphone 400 having a balanced armature acoustic transducer 402, in accordance with embodiments of the present disclosure. Earphone 400 may be particularly useful for headphone assemblies that either incorporate or are used with devices that incorporate adaptive noise cancellation and/or feedback-based signal processing solutions for improving the sound quality of the insert earphone. Earphone 400 may comprise a housing including a balanced armature acoustic transducer 402, a speaker tube 404, and a screen 406 coupled together and configured in a manner similar to that shown in FIG. 7.

A reference microphone 212 may be mounted towards the back of earphone 400 as shown in FIG. 7. Error microphone 120 may be mounted and located to a side of earphone 400. A microphone port tube 114C may be coupled to error microphone 120 as shown in FIG. 7. The microphone port tube 114C may extend from the error microphone 120 that is at a side of earphone 400 to the center of screen 406. The error microphone tube entrance 408 abuts the center of screen 406.

Microphone port tube 114C may comprise any acoustical conduit coupled to and extending from error microphone 120 and passing through or otherwise adjacent to screen 406 such that acoustical pressure present proximate to the front of screen 406 is communicated to error microphone 120. Microphone port tube 114C may have any suitable shape and/or cross-section, including an open cylindrical tube (e.g., circular cylindrical tube, triangular cylindrical tube, rectangular cylindrical tube, etc.). Similar to microphone port tube 114A, the size or area of the microphone port tube 114C may be much smaller than the size or area of the error microphone 120. Due to the size and/or placement of microphone port tube 114C and error microphone 120, microphone port tube 114C and error microphone 120 may not substantially obstruct the functionality or acoustic wave path of balanced armature acoustic transducer 402.

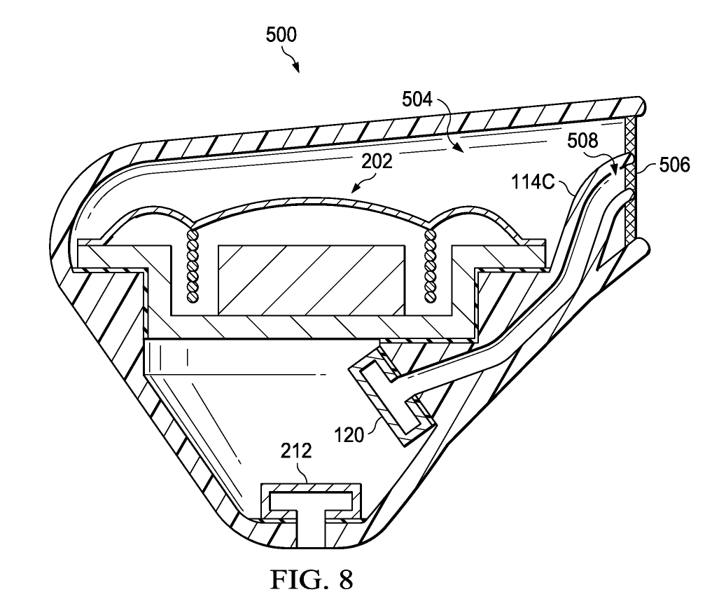

FIG. 8 is an illustration including a cross-sectional elevation view of an example intra-concha earphone 500 having a dynamic acoustic transducer 202, in accordance with embodiments of the present disclosure. Earphone 500 may be particularly useful for intra-concha headphone assemblies that either incorporate or are used with devices that incorporate adaptive noise cancellation and/or feedback-based signal processing solutions for improving the sound quality of the headphone assembly. Earphone 500 may comprise a housing including a dynamic acoustic transducer 202, a speaker tube 504, and a screen 506 coupled together and configured in the manner shown in FIG. 8.

A reference microphone 212 can also be mounted towards the back of earphone 500 as shown in FIG. 8. Error microphone 120 may be also mounted and located to a side of acoustic transducer configuration 500 as shown in FIG. 8. A microphone port tube 114C may be coupled to error microphone 120 as shown in FIG. 8. The microphone port tube 114C may extend from error microphone 120 that is at a side of earphone 500 to a center area of screen 506. The error microphone tube entrance 508 may abut the center area of screen 506.

Microphone port tube 114C may comprise any acoustical conduit coupled to and extending from error microphone and passing through or otherwise adjacent to screen 506 such that acoustical pressure present proximate to the front of screen 506 is communicated to error microphone 120. Microphone port tube 114C may have any suitable shape and/or cross-section, including an open cylindrical tube (e.g., circular cylindrical tube, triangular cylindrical tube, rectangular cylindrical tube, etc.). Similar to microphone port tube 114A, the size or area of the microphone port tube 114C is also much smaller than the size or area of the error microphone 120. Due to the size and/or placement of microphone port tube 114C and error microphone 120, microphone port tube 114C and error microphone 120 may not substantially obstruct the functionality or acoustic wave path of acoustic transducer 202.

Thus, in the embodiments represented by earphones 200, 400, and 500, an earphone may include an acoustic transducer (e.g., 202, 402) configured to produce sound in response to an audio signal input to the acoustic transducer (e.g., a voice coil of the acoustic transducer). A first acoustical conduit (e.g., speaker tube 204, speaker tube 404, speaker tube 504) may be coupled to and extend from the acoustic transducer for acoustically conducting sound from the acoustic transducer to an end of the acoustical conduit opposite the acoustic transducer. A microphone (e.g., error microphone 120) may sense combined acoustical pressure of sound produced by the acoustic transducer and ambient sound proximate to the end of the first acoustical conduit opposite the acoustic transducer. A second acoustical conduit (e.g., microphone port tube 114C) may be coupled to and extending from the microphone and to a location proximate to the end of the first acoustical conduit opposite the acoustic transducer such that the microphone senses acoustic pressure proximate to the end of the first acoustical conduit. As is depicted in FIGS. 5A-8, at least a portion of the second acoustical conduit may be contained within at least a portion of the first acoustical conduit. Also as shown in FIGS. 5A-8, at least a portion of the second acoustical conduit may share a boundary with at least a portion of the first acoustical conduit.

Although particular types of earphones are depicted in FIGS. 5A-8, the systems and methods therein may be applied to any suitable type of headphone, including without limitation an intra-concha earphone, a supra-concha earphone, and a supra-aural earphone.

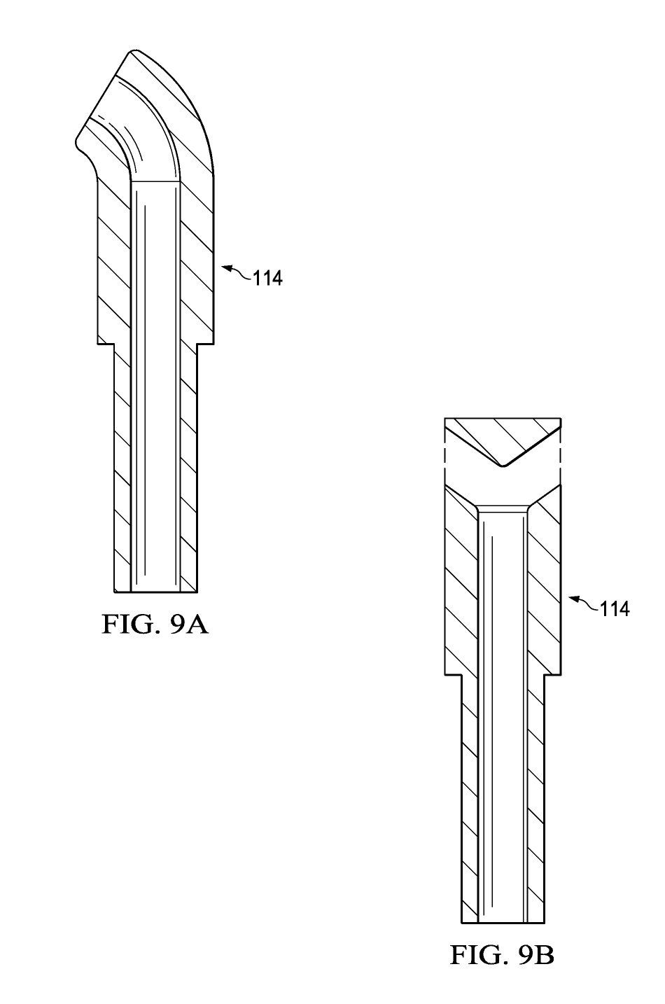

FIGS. 9A and 9B are each an illustration including a cross-sectional elevation view of a terminus of a microphone port tube 114, in accordance with embodiments of the present disclosure. In the various embodiments depicted in FIGS. 4A-8, microphone port tubes 114A, 114B, and 114C are depicted as having openings at their respective termini (e.g., the end of such microphone port tube 114A proximate to the acoustic output of its associated transducer and/or the end of such microphone port tubes 114B and 114C proximate to the acoustic output speaker tube 204, speaker tube 404, and/or speaker tube 504) wherein such openings face in substantially the same direction of front of the associated transducer or in substantially the same direction of the openings of the associated speaker tubes. With such shape and/or orientation, in some instances, sound incident on portions of a listener's ear and/or ear canal (e.g., the tympanic membrane) may reflect from the listener's ear and/or ear canal back to the microphone port tube 114A, 114B, or 114C. Any such reflected sound that reaches error microphone 120 may affect adaptive noise cancellation (e.g., performed by ANC circuit 20) based on a signal generated by error microphone 120, possibly leading to inaccurate modeling by the adaptive noise cancellation system. Accordingly, in some embodiments of the present disclosure, a microphone port tube 114 (which may be used in place of microphone port tubes 114A, 114B, and 114C depicted in FIGS. 4A-8) may be shaped at its terminus to reduce or eliminate reflection of sound from a listener's ear or ear canal to error microphone 120. For example, as shown in FIG. 9A, microphone port tube 114 may be curved or elbowed at its terminus so as to avoid direct reflection from a listener's ear or ear canal to error microphone 120. As another example, as shown in FIG. 9B, microphone port tube 114 may be “capped” at its terminus, with a plurality of ports formed on the sides of microphone port tube 114 near the terminus, such that the plurality of ports face perpendicular to the length of microphone tube 114.

As used herein, the placement of an end or terminus of a microphone port tube 114, 114A, 114B, and/or 114C “proximate” to an acoustic output of an acoustic transducer and/or a speaker tube 204, 404, and/or 504, means that the end or terminus is adjacent to, to the side of, near, close, and/or spaced from the relevant acoustic output such that sound conducted from the end or terminus through the microphone port tube to the associated error microphone is of a magnitude sufficient for the error microphone to sense the sound at the acoustic output and generate an electric signal indicative of the sound present at the acoustic output.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An apparatus comprising:
an acoustic transducer comprising a diaphragm having a front and a back, the diaphragm configured to mechanically vibrate in response to an audio signal input to the acoustic transducer, thereby producing sound from the front of the diaphragm;
a housing configured to mechanically support the acoustic transducer such that the front faces an exterior of the housing and the back faces an interior of the housing;
a microphone disposed in the interior of the housing for sensing combined sound produced by the acoustic transducer and ambient sound proximate to the acoustic transducer; and
an acoustical conduit coupled to and extending from the microphone and passing adjacent to the acoustic transducer such that the microphone senses sound proximate to the front of the diaphragm.

2. The apparatus of claim 1, wherein an end of the acoustical conduit opposite the microphone is substantially flush with the front of the diaphragm.

3. The apparatus of claim 1, comprising an air gap between the diaphragm and the acoustical conduit.

4. The apparatus of claim 3, wherein an end of the acoustical conduit opposite the microphone extends substantially beyond the front of the acoustic transducer.

5. The apparatus of claim 1, the acoustic conduit comprising an open cylindrical tube.

6. The apparatus of claim 1, wherein the acoustical conduit extends from the microphone and passes through the acoustic transducer.

7. The apparatus of claim 1, wherein a terminus of the acoustical conduit opposite the microphone is shaped to reduce or eliminate reflections of sound from a listener's ear or ear canal to the error microphone.

8. A method comprising:
providing an acoustic transducer comprising a diaphragm having a front and a back, the diaphragm configured to mechanically vibrate in response to an audio signal input to the acoustic transducer, thereby producing sound from the front of the diaphragm;
mechanically supporting the acoustic transducer in a housing such that the front faces an exterior of the housing and the back faces an interior of the housing;
disposing a microphone in the interior of the housing for sensing combined sound produced by the acoustic transducer and ambient sound proximate to the acoustic transducer; and
coupling an acoustical conduit to the microphone such that the acoustical conduit extends from the microphone and passes through the acoustic transducer such that the microphone senses sound proximate to the front of the diaphragm.

9. The method of claim 8, further comprising configuring the acoustical conduit such that an end of the acoustical conduit opposite the microphone is substantially flush with the front of the diaphragm.

10. The method of claim 8, further comprising forming an air gap between the diaphragm and the acoustical conduit.

11. The method of claim 10, further comprising configuring the acoustical conduit such that an end of the acoustical conduit opposite the microphone extends substantially beyond the front of the acoustic transducer.

12. The method of claim 8, the acoustic conduit comprising an open cylindrical tube.

13. The method of claim 8, wherein the acoustical conduit extends from the microphone and passes through the acoustic transducer.

14. The method of claim 8, wherein a terminus of the acoustical conduit opposite the microphone is shaped to reduce or eliminate reflections of sound from a listener's ear or ear canal to the error microphone.

15. An apparatus comprising:
an acoustic transducer configured to produce sound in response to an audio signal input to the acoustic transducer;
a first acoustical conduit coupled to and extending from the acoustic transducer for acoustically conducting sound from the acoustic transducer to an end of the acoustical conduit opposite the acoustic transducer;
a microphone sensing combined sound produced by the acoustic transducer and ambient sound proximate to the end of the first acoustical conduit opposite the acoustic transducer; and
a second acoustical conduit coupled to and extending from the microphone and to a location proximate to the end of the first acoustical conduit opposite the acoustic transducer such that the microphone senses sound proximate to the end of the first acoustical conduit.

16. The apparatus of claim 15, wherein at least a portion of the second acoustical conduit is contained within at least a portion of the first acoustical conduit.

17. The apparatus of claim 15, wherein at least a portion of the second acoustical conduit shares a boundary with at least a portion of the first acoustical conduit.

18. The apparatus of claim 15, further comprising a housing configured to enclose the acoustic transducer, the microphone, the first acoustical conduit, and the second acoustical conduit.

19. The apparatus of claim 18, wherein the housing comprises an earphone.

20. The apparatus of claim 19, wherein the earphone comprises one of an intra-canal earphone, an intra-concha earphone, a supra-concha earphone, and a supra-aural earphone.

21. The apparatus of claim 15, wherein a terminus of the second acoustical conduit at the location is shaped to reduce or eliminate reflections of sound from a listener's ear or ear canal to the error microphone.

22. A method comprising:
providing an acoustic transducer configured to produce sound in response to an audio signal input to the acoustic transducer;
coupling a first acoustical conduit to the acoustic transducer such that the first acoustical conduit extends from the acoustic transducer and acoustically conducts sound from the acoustic transducer to an end of the first acoustical conduit opposite the acoustic transducer;
providing a microphone for sensing combined sound produced by the acoustic transducer and ambient sound proximate to the end of the first acoustical conduit opposite the acoustic transducer; and
coupling a second acoustical conduit to the microphone such that the second acoustical conduit extends from the microphone and to a location proximate to the end of the first acoustical conduit opposite the acoustic such that the microphone senses sound proximate to the end of the first acoustical conduit.

23. The method of claim 22, further comprising containing at least a portion of the second acoustical conduit within at least a portion of the first acoustical conduit.

24. The method of claim 22, further comprising orienting the second acoustical conduit such that at least a portion of the second acoustical conduit shares a boundary with at least a portion of the first acoustical conduit.

25. The method of claim 22, further comprising enclosing the acoustic transducer, the microphone, the first acoustical conduit, and the second acoustical conduit with a housing.

26. The method of claim 25, wherein the housing comprises an earphone.

27. The method of claim 26, wherein the earphone comprises one of an intra-concha earphone, an intra-concha earphone, a supra-concha earphone, and a supra-aural earphone.

28. The method of claim 22, wherein a terminus of the second acoustical conduit at the location is shaped to reduce or eliminate reflections of sound from a listener's ear or ear canal to the error microphone.
